(19) United States
(12) Patent Application Publication
(10) Pub. No.: US 2006/0216427 A1
(43) Pub. Date: Sep. 28, 2006

(54) Treatment of flexible web material

(75) Inventors: Shaun Christopher Hazlewood, Suffolk (GB); Stephen Brown, Herts (GB); John Christopher Corrall, Cambs (GB)

Correspondence Address: MORGAN LEWIS & BOCKIUS LLP, 1111 PENNSYLVANIA AVENUE NW, WASHINGTON, DC, 20004, US

(73) Assignee: Conductive Inkjet Technology Limited

(21) Appl. No.: 11/384,825

(22) Filed: Mar. 21, 2006

Related U.S. Application Data
(60) Provisional application No. 60/663,760, filed on Mar. 22, 2005.

(30) Foreign Application Priority Data
Mar. 22, 2005 (GB) 0505822.7

(51) Int. Cl. B05D 1/18

(52) U.S. Cl. 427/430.1; 118/420

(57) ABSTRACT

A method of immersing a flexible web of material in a fluid, the method comprising delivering the web to the fluid and subsequently withdrawing the web from the fluid, wherein the web passes through the fluid not under tension. Thus, the web is not constrained by any tensioning means to follow a particular path through the fluid. The web may instead by constrained by one or more walls confining the fluid, typically walls of a fluid container. In this case the path taken by the web through the fluid and the speed of delivery to and withdrawal from the fluid. The invention also covers corresponding apparatus.

### FIELD OF THE INVENTION

This invention relates to the treatment of flexible webs of material, particularly (but not exclusively) to the application of an electrically conducting layer to a moving web of material such as polyester.

### BACKGROUND TO THE INVENTION

In order to perform chemical reactions on a moving web of material (for example electroless deposition of copper onto an activated catalytic material for the developing of photographic images), the web has traditionally been sequentially immersed in a series of baths of liquids. As a practical necessity for these processes, the web has been wound around a series of rollers in order to control its path through the baths, and in some cases the web is wound in a serpentine path around these rollers in order to prolong its time in a particular bath. When a moving web is immersed in a bath of liquid in order to effect a chemical reaction, the time allowed for such a reaction to take place is governed by the speed at which the web travels and the total length of path which the web takes through the liquid bath. The more tortuous the path, the longer the web spends in the liquid for a given speed of web translation. Traditionally, the web is kept in tension and guided along its path by winding it around a series of rollers disposed in the liquid. These methods have the disadvantage of requiring large volumes of liquid and complex mechanical systems which usually involve cantilevered rollers mounted on a backplane. In many cases the rollers must be fabricated out of inert materials or otherwise sealed in order to protect their bearings from the chemical environment of the reaction baths. The present invention aims to reduce the complexity of such processes.

### SUMMARY OF THE INVENTION

According to one aspect of the invention a method of immersing a flexible web of material in a fluid comprises delivering the web to the fluid and subsequently withdrawing the web from the fluid, wherein the web passes through the fluid not under tension.

The web is not constrained by tensioning means, nor typically by path-defining guides, within the fluid. The web may instead be constrained by one or more walls confining the fluid, typically walls of a fluid container or the walls of an apertured cage within a fluid container.

The path followed by the web within the fluid may be in the general shape of a catenary or parabolic loop, but in circumstances where it is desirable for the web to follow a longer path within the fluid the path may be of a sinuous or serpentine shape, having a plurality of superposed folds from the lowest of which the web moves generally upwardly through the fluid before being withdrawn therefrom. In this case, there are no tensioning means such as rollers or other guides between the folds of the web.

According to another aspect of the invention, apparatus for immersing a flexible web of material in a fluid comprises a container for accommodating the fluid, a first device for feeding the web into the fluid and a second device for withdrawing the web from the fluid, there being no tensioning means within the body of fluid to influence the path taken by the web as it passes though the fluid.

Thus, the web is not constrained by any tensioning means to follow a particular path through the fluid. In the invention, the path taken by the web through the fluid will be dependent on factors such as the size of the container, the depth of fluid and the speed of delivery to and withdrawal from the fluid. Unlike the prior art, there are no tensioning means, and typically no guide means, for the web within the body of the fluid.

Preferably, the first device and the second device are operated to feed and withdraw the web at the same speed, so that the length of web immersed within the fluid remains constant. The first and second devices may be positioned outside the container, e.g. above the container at horizontally spaced positions, enabling the web to pass downwardly into the fluid and to be withdrawn upwardly from the fluid. The first and/or second devices may alternatively be positioned within the container.

In use, the web is fed to the container by the first device, typically being fed from a supply roll, e.g. mounted on a brake roller, located remotely from the container. A brake roller is a roller the motion of which is retarded by maintaining a set drag force such that a finite torque is required to keep it rotating. The web is removed from the container by the second device, typically being passed to a take up roll, e.g. mounted on a clutch roller, located remotely from the container. A clutch roller is a roller which is rotated with a controlled torque rather than a controlled speed. Such a roller can be used to rewind a web of material and keep the web under a controlled tension while its speed is controlled by other means, e.g. a set of pinch rollers which transport the web at a fixed speed.

In the preferred embodiments to be described, the first device is constituted by a first pair of pinch rollers driven to feed the web into the fluid and the second device is constituted by a second pair of pinch rollers driven to withdraw the web from the fluid with the web possibly passing over one or more intermediate rollers. Another embodiment instead uses three contacting rollers, with only the middle roller being driven and constituting a component of both the first device and the second device. The embodiment has the benefit of ensuring that the first and second devices feed the web at the same speed (determined by the speed of rotation of the middle roller).

Immersion of the web in the fluid may be for any purpose, but preferably a chemical reaction takes place between the web and the fluid. For example, the web of material may be a polyester and the fluid may be a liquid which, by chemical reaction, imparts to the polyester an electrically conducting layer, such as copper. Other possibilities include photographic development, etching, dissolution, stripping, etc. The fluid may also be constituted by a controlled environment within the container, e.g. a gaseous environment having specified characteristics, e.g. humidity, temperature etc.

### BRIEF DESCRIPTION OF THE DRAWINGS

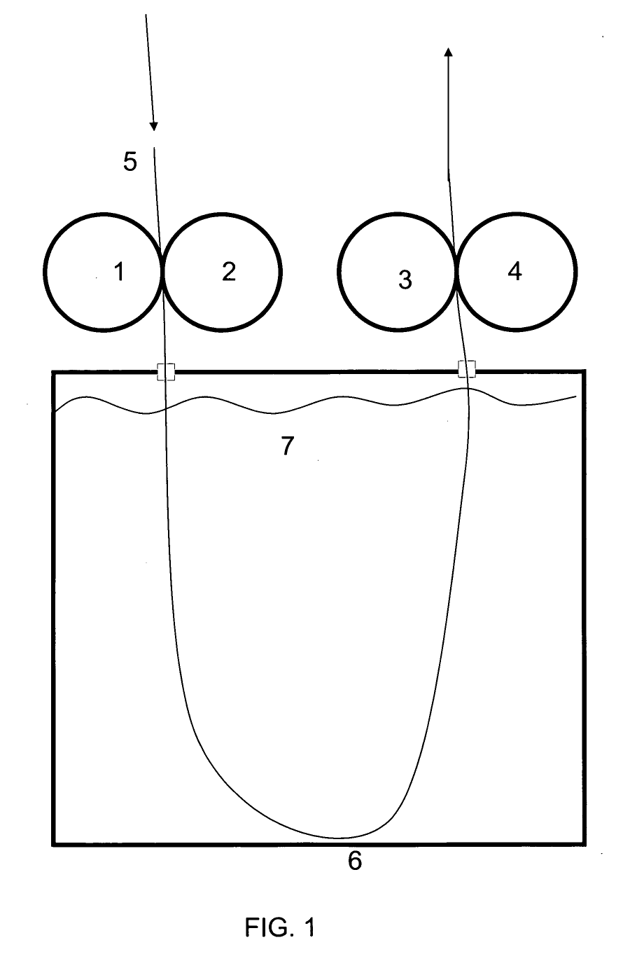

Three preferred embodiments of the invention will now be described, by way of example, with reference to the accompanying drawings in which FIGS. 1, 2 and 3 are diagrammatic side views of the three embodiments.

### DETAILED DESCRIPTION OF THE DRAWINGS

In the first embodiment shown in FIG. 1, the apparatus comprises a first pair of pinch rollers 1, 2 (constituting the first device) and a second pair of pinch rollers 3, 4 (constituting the second device), with both pairs of pinch rollers being disposed above a container 6 accommodating a treatment liquid 7. A web 5 of Melinex polyester (Melinex is a trademark) is fed into the liquid 7 by the first pair of pinch rollers 1, 2 and is withdrawn from the liquid 7 by the second pair of pinch rollers 3, 4. Both pairs of pinch rollers are driven at the same rotational speed but in opposite directions so that the web 5 enters the container 6 at the same linear speed as it leaves the container 6, with the result that the web follows a path through the liquid 7 having a constant length. As can be seen from FIG. 1, the path is in the shape of a downwardly depending loop, similar in shape to a catenary or a parabola. It can be seen that the web is not guided by any rollers or guide means as it passes through the liquid, with the result that the web is not constrained or tensioned other than by the tension imposed by the second set of pinch rollers 3, 4 and by any constraint imposed by the containing walls of the container 6.

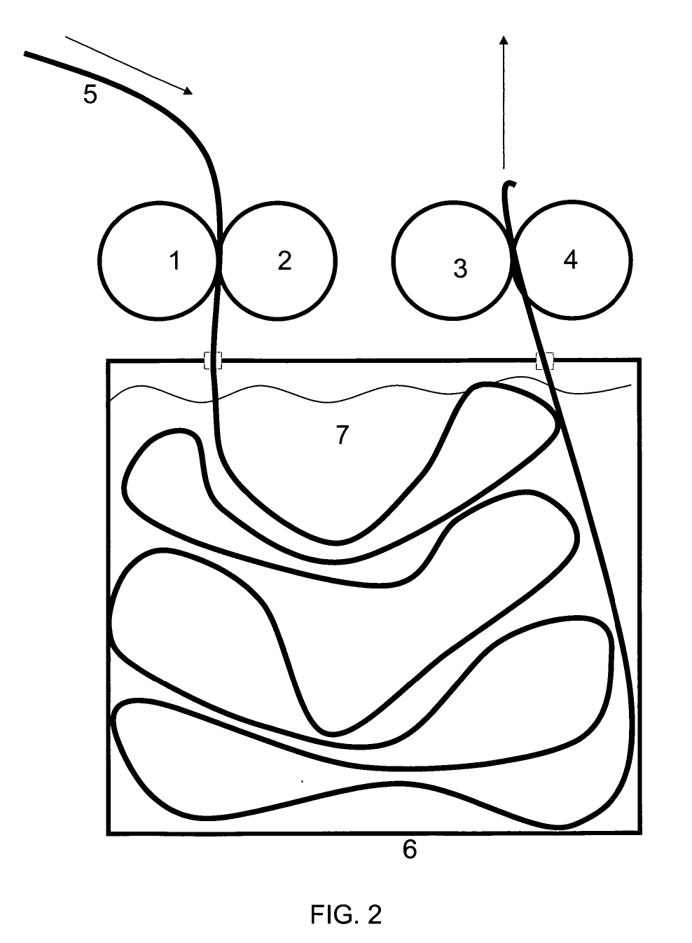

In FIG. 2, where the same reference numerals denote corresponding components to those of FIG. 1, the web 5 follows a path which has a sinuous or serpentine shape, there being a number of superposed folds from the lower of which the web is withdrawn upwardly through the liquid by the second set of pinch rollers 3, 4. Here again, the web 5 is allowed to define its own path and may follow a complex route and may turn back on itself several times. Provided that the loops at the ends of the turns are not compressed excessively then no plastic deformation or creasing of the web 5 should occur.

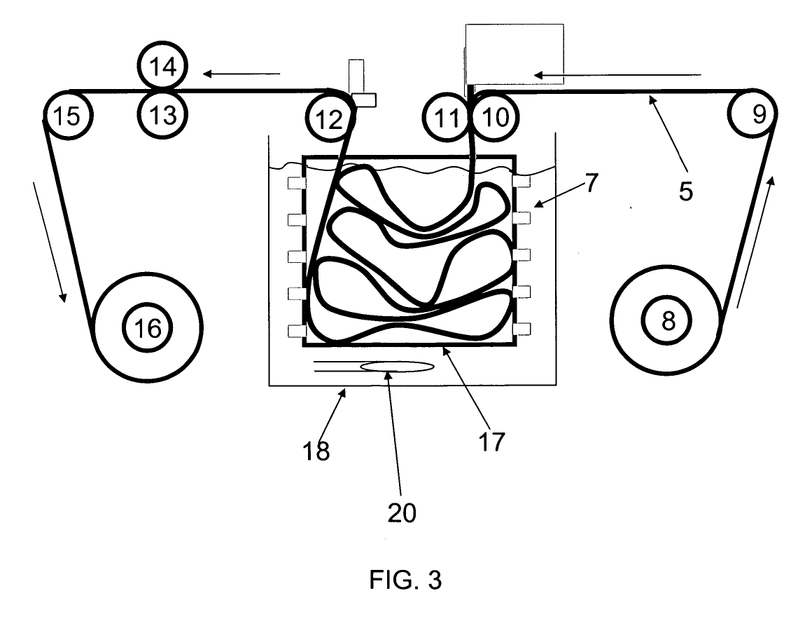

In FIG. 3, where the same reference numerals denote corresponding components to those in FIG. 1, the web 5 is passed from a break roller 8 through a first system of rollers, passing through a treatment liquid 7, and through a second system of rollers, to be taken up on a clutch roller 16.

In the first system of rollers the web 5 is driven by driven pinch rollers 10, 11 (constituting the first device) which rotate is opposite directions so as to feed the web in a substantially vertical direction into the treatment liquid 7. The web is kept in tension around an idle roller 9 by the action of the break roller 8, which is retarded by maintaining a set drag force such that a finite torque is required to keep it rotating.

The treatment fluid 7 is confined within a polypropylene tank 18. Immersed in the tank 18 is a PVC cage 17 fabricated with perforated sides to allow free flow of fluid 7 through its structure. The perforated sides are sized so that the web 5 cannot pass through them. The fluid can be maintained at a constant temperature by action of a thermostatically controlled immersion heater coil 20.

The web 5 is passed vertically down into the treatment fluid 7 and enters the PVC cage 17. The perforations in the cage 17 are sufficiently small so as not to allow the web to pass through them. The web 5 then follows a path generally as described in FIG. 2. The web 5 leaves the fluid 7 and exits the cage 17 substantially vertically.

In the second system of rollers, the web 5 is driven by pinch rollers 13, 14 (constituting the second device) which translate the web 5 at the same speed as pinch rollers 10, 11 so as to maintain a constant length of web in the fluid 7. The horizontal tension imposed on the web 5 is converted into an upwards force via the action of an idle roller 12. The tension is balanced by the inertia of the web and the idle roller 12 so as to leave the web 5, which is disposed in the fluid 7, substantially free of tension.

The web 5 is rewound onto clutch roller 16, which maintains tension in the web 5 as it passes over idle roller 15 by rotating with a controlled torque rather than a controlled speed. The clutch roller can thus be used to rewind the web and keep the web under a controlled tension while the speed of the web is controlled by the pinch rollers 13, 14 which transport the web at a fixed speed.

In FIGS. 1, 2 and 3 the apparatus may effect the electro-less plating of a continuously moving web of polyester, for example to effect electro-less deposition of copper onto the web. The time for which the web 5 is immersed in the liquid 7 (determined by the speed of the rollers and the path length) is chosen to enable the required chemical reaction between the liquid 7 and the web 5 to be completed.

If the web is moving at 0.5 m/s and 10 m of material is coiled inside the container then each area of web would spend a total of 20 seconds within the container. Since no rollers are required in order to maintain this path, the whole arrangement may be wound into a far smaller space.

As well as reducing the footprint and size of equipment needed, this system also has the following benefits:
1. A smaller volume of liquid is required. This is especially useful if the chemicals involved are particularly expensive.
2. The mass of the equipment is far lower—easier transport and equipment handling and may be used on upper floors.
3. The smaller volume of liquid may be heated quickly with a relatively low power of heater.
4. Agitation, recirculation and filtering are easier with such low volumes.

As another benefit, the system may be treated as an independent cartridge and may be pre wound with a particular length of dummy material. In this way it can be introduced into a continuous reel to reel system by splicing the dummy web into the existing line. This ensures that the correct length of material is wound into the cartridge and simplifies installation.

Similarly, if several chemical treatments are required many such cartridges may be spliced together in order to provide consecutive in-line processes.

### EXAMPLE 1

In a typical embodiment a web 5 of Melinex 339 polyester (from DuPont Teijin Films) 100 microns thick and 50 mm wide had pre-printed on one surface thereof a palladium acetate activator solution. The solution was applied thereto in a pattern on only selected areas of the surface by inkjet printing, generally as described in WO 2004/068389. In particular, the following activator solution was prepared:

| | % (by weight) |
|---|---|
| Palladium acetate | 2.0 |
| Irgacure 1700 | 3.25 |
| Irgacure 819 | 1.25 |
| DPGDA | 30.5 |
| DPHA | 3.0 |
| Actilane 505 | 10.0 |
| Diacetone alcohol | 47.5 |
| PVP K30 | 2.5 |
| Viscosity, cPs (25° C.) | 17.6 |

Palladium acetate is present as an activator. Irgacure 1700 and Irgacure 819 are UV photo-initiators supplied by Ciba Speciality Chemicals, Macclesfield, UK—Irgacure is a Trade Mark. DPGDA is dipropylene glycol diacrylate, a UV-curable reactive diluent monomer supplied by UCB, Dragenbos, Belgium. DPHA is dipentaerythritol hexacrylate, a UV-curable hexafunctional monomer, supplied by UCB, Dragenbos, Belgium. Actilane 505 is a UV-curable reactive tetrafunctional polyester acrylate oligomer supplied by Akzo Nobel UV Resins, Manchester, UK. The monomers and oligomers are in liquid form.

Diacetone alcohol is a solvent for the palladium acetate. PVP K30 is a grade of polyvinyl pyrrolidinone supplied by ISP, Tadworth, UK.

PVP constitutes a water soluble chemical functionality. The monomers and oligomers, Actilane 505, DPHA and DPGDA, react to form a polymer that constitutes a water insoluble chemical functionality.

This fluid was printed with a XJ500/180 print head (available from Xaar of Cambridge, England) at 180×250 dpi. The samples were then cured under a Fusion 500 Watt H-bulb, in 4 passes of 20 metres/min each, resulting in formation of an activator layer.

The pre-printed web 5 was fed to apparatus as shown in FIG. 2. Container 6 comprises a rectangular tank with internal dimensions 25 cm deep×25 cm with a width of 52 mm to accommodate the 50 mm wide web.

The tank is substantially filled with an electroless copper plating solution comprising Enplate 872 A, B and C reagents (Enplate is a Trade Mark) which are available from Enthone-OMI and are in common use as component solutions for electroless copper plating. In particular, the electroless copper plating solution has the following composition:

| | % (by weight) |
|---|---|
| Enplate 872 A | 10.713 |
| Enplate 872 B | 10.713 |
| Enplate 872 C | 3.571 |
| water | balance to 100% |

Enplate 872A contains copper sulphate, formaldehyde, complexing agent (Quadrol) and water; Enplate 872B contains a complexing agent (Quadrol), and water; Enplate 872C contains potassium cyanide, sodium hydroxide, and water. Quadrol is a Trade Mark. Quadrol is N,N,N′,N′-Tetrakis(2-hydroxypropyl)ethylenediamine.

For reaction at room temperature (about 25° C.) a dwell time of 2 minutes is appropriate. For a 10 m length of material in the container, this requires a web speed of 0.083 m/s.

This treatment produced a conductive copper film on the regions of the web surface to which the activator solution had been applied.

### EXAMPLE 2

A web 5 of Melinex 339 polyester (from DuPont Teijin Films) 100 microns thick and 152 mm wide had pre-printed on one surface thereof a palladium acetate activator solution as previously described in Example 1.

The web 5 was wound onto a 72 mm diameter cardboard core and mounted onto a break roller 8. The web was then passed through the arrangement as described in FIG. 3.

The tank 18 is filled with an electroless copper plating solution, as described above in Example 1. The perforations in the sides of the cage 17 are less than 25 mm in extent and therefore do not allow the web to pass through them. Thus, the cage 17 confines the motion of the web 5.

As discussed above, by varying the speed of the web and the length of material which is disposed in the fluid-containing system, the exposure time of the web to the fluid can be accurately controlled. By allowing 20 m of web to be accumulated in the fluid-containing system and translating the web at 0.3 ms⁻¹, the web is exposed to the liquid for approximately 67 seconds. In this time a copper layer builds up on the printed regions of the web. This layer is built up to sheet resistance of around 310 mohm/square. By reducing the web speed to 0.1 ms⁻¹ the copper layer is built up to a greater thickness and hence a lower surface resistivity of around 102 mohm/square.

By driving the pinch rollers 10 and 11 while the pinch rollers 13 and 14 remain stationary, more web may be accumulated in the fluid-containing system. When the length of exposed web is increased to 30 m and translated at a speed of 0.1 ms⁻¹ the copper layer which is built up is seen to have a surface resistivity of around 70 mohm/square.

1. A method of immersing a flexible web of material in a fluid, the method comprising delivering the web to the fluid and subsequently withdrawing the web from the fluid, wherein the web passes through the fluid not under tension.

2. A method according to claim 1, wherein the web passes downwardly into the fluid and is withdrawn upwardly from the fluid in a continuous process.

3. A method according to claim 2, wherein the path followed by the web within the fluid is in the general shape of a catenary or parabolic loop.

4. A method according to claim 3, wherein the path followed by the web within the fluid is of a sinuous or serpentine shape, having a plurality of superposed folds, from the lowest of which the web moves generally upwardly through the fluid before being withdrawn therefrom.

5. A method according to claim 4, wherein there are no tensioning means between the folds of the web.

6. A method according to claim 1, wherein the web of material is a polyester and the fluid is a liquid which forms on the polyester web an electrically conducting layer, such as copper.

7. Apparatus for immersing a flexible web of material in a fluid, the apparatus comprising a container for accommodating the fluid, a first device for feeding the web into the fluid and a second device for withdrawing the web from the fluid, there being no tensioning means within the body of fluid to influence the path taken by the web as it passes through the fluid.

8. Apparatus according to claim 7, wherein the first and second devices are positioned above the container at horizontally spaced positions, enabling the web to pass downwardly into the container and to be upwardly withdrawn therefrom.

9. Apparatus according to claim 7 or 8, wherein the first device and the second device are operative to feed and withdraw the web at the same speed, so that the path length of the web immersed within the fluid remains constant.

10. Apparatus according to claim 7 or 8, wherein the first device is constituted by a first pair of pinch rollers driven to feed the web into the fluid and the second device is constituted by a second pair of pinch rollers driven to withdraw the web from the fluid.
